(19) United States
(12) Patent Application Publication
(10) Pub. No.: US 2016/0107426 A1
(43) Pub. Date: Apr. 21, 2016

(54) POLYMER FILM WITH RENEWABLE CONTENT

(71) Applicant: TRISTANO PTY LTD, Mount Waverley (AU)

(72) Inventor: Markus Leufgens, Frankston (AU)

(21) Appl. No.: 14/893,863

(22) PCT Filed: May 29, 2014
(86) PCT No.: PCT/AU2014/050054

§ 371 Date: Nov. 24, 2015

(30) Foreign Application Priority Data
May 29, 2013 (AU) 2013901913

(51) Int. Cl. B32B 27/08; B29C 47/06; B32B 27/32; B29C 47/00; B32B 1/02; B32B 7/02

(52) U.S. Cl. CPC B32B 27/08; B32B 1/02; B32B 7/02; B32B 27/327; B32B 27/32; B29C 47/0004; B29C 47/0021; B29C 47/065; B32B 2250/03; B32B 2307/72; B32B 2439/46; B29K 2003/00; B29K 2023/0608

(57) ABSTRACT

Disclosed is a polymer film having a multilayer structure, the multilayer structure including an inner polymer layer interposed between first and second outermost polymer layers, wherein: (i) the inner polymer layer includes a melt blend of: (a) a starch containing a polymer composition including polyethylene, thermoplastic starch, and one or more compatibilizers; (b) a metallocene polyethylene having a melt flow index in the range of 0.5 to 2.5 g/10 min and a density in the range of 0.910 to 0.935 g/cm³; (c) a polyethylene having a melt flow index in the range of 2 to 4 g/10 min and a density in the range of 0.918 to 0.925 g/cm³; and (d) a polyethylene have a melt flow index in the range of 0.05 to 0.2 g/10 min and a density in the range of 0.948 to 0.955 g/cm³; (ii) the first and second outermost polymer layers independently (a) include a metallocene polyethylene having a melt flow index in the range of 0.5 to 2.5 g/10 min and a density in the range of 0.916 to 0.935 g/cm³, or (b) have a heat seal initiation temperature of no greater than 120° C., wherein at least one of the first and second outermost polymer layers has a heat seal initiation temperature of no greater than 120° C.

### FIELD OF THE INVENTION

The present invention relates in general to polymer films, and in particular to polymer films with renewable content. The invention also relates to a process for preparing the polymer films, and to articles comprising or produced from the films.

### BACKGROUND OF THE INVENTION

To meet ever increasing performance demands such as tear and puncture resistance, gas impermeability, sealability and clarity, modern packaging films can be quite complex in terms of both their structure (e.g. multilayer) and composition (e.g. type of polymer(s)).

Due to its excellent physical and mechanical properties, processability and clarity, polyethylene is used extensively in the manufacture of packaging films. However, polyethylene is to date ultimately derived from crude oil, and there is now a concerted effort in the packaging industry to avoid or at least reduce the use of such oil based polymers in favour of sustainable, bio-derived alternatives.

Much of the research to date in developing such sustainable, bio-derived alternatives has focussed on utilising naturally occurring bio-polymers such as starch. Starch is an attractive alternative in that it is derived from renewable resources (i.e. plant products), readily available and relatively inexpensive.

Despite being derived from a renewable resource, a biopolymer such as starch typically exhibits inferior mechanical properties relative to the oil derived polymers and consequently has found limited industrial application.

In an attempt to obtain the advantageous properties of both classes of polymer, blends of biopolymers and oil derived polymers have been prepared. For example, considerable research has been directed toward developing starch/polyethylene blends.

However, the inherent incompatibility between starch and polyethylene typically results in the formation of a multi-phase morphology having a high interfacial tension that often negatively impacts on the physical and mechanical properties of the resulting polymer composition. For example, the presence of starch within a polyethylene matrix is known to promote a significant reduction in the resulting polymers gloss, elongation properties, toughness, tear strength, puncture resistance and clarity.

Compatibilisers can be used to assist with improving the properties of polyethylene/starch blends. However, to date polymer compositions comprising polyethylene and starch still typically exhibit inferior physical and mechanical properties relative to polyethylene compositions absent the starch.

Accordingly, there remains an opportunity to develop polyethylene polymer systems incorporating renewable content such as starch that exhibit comparable physical and mechanical properties to polyethylene polymer systems absent the renewable content.

### SUMMARY OF THE INVENTION

The present invention therefore provides polymer film having a multilayer structure, the multilayer structure comprising an inner polymer layer interposed between first and second outermost polymer layers, wherein:

(i) the inner polymer layer comprises a melt blend of:
(a) a starch containing polymer composition comprising polyethylene, thermoplastic starch, and one or more compatibilisers;
(b) a metallocene polyethylene having a melt flow index in the range of 0.5 to 2.5 g/10 min and a density in the range of 0.910 to 0.935 g/cm³;
(c) polyethylene having a melt flow index in the range of 2 to 4 g/10 min and a density in the range of 0.918 to 0.925 g/cm³; and
(d) polyethylene have a melt flow index in the range of 0.05 to 0.2 g/10 min and a density in the range of 0.948 to 0.955 g/cm³; and
   (ii) the first and second outermost layers independently (a) comprise a metallocene polyethylene having a melt flow index in the range of 0.5 to 2.5 g/10 min and a density in the range of 0.916 to 0.935 g/cm³, or (b) have a heat seal initiation temperature of no greater than 120° C., wherein at least one of the first and second outermost layers has a heat seal initiation temperature of no greater than 120° C.

The present invention further provides a process for producing polymer film having a multilayer structure, the multilayer structure comprising an inner polymer layer interposed between first and second outmost polymer layers, the process comprising forming the multilayer structure by co-extruding the inner polymer layer interposed between the first and second outermost polymer layers, wherein:
(i) the inner polymer layer comprises a melt blend of:
   (a) a starch containing polymer composition comprising polyethylene, thermoplastic starch, and one or more compatibilisers;
   (b) a metallocene polyethylene having a melt flow index in the range of 0.5 to 2.5 g/10 min and a density in the range of 0.916 to 0.935 g/cm³;
   (c) polyethylene having a melt flow index in the range of 2 to 4 g/10 min and a density in the range of 0.918 to 0.925 g/cm³; and
   (d) polyethylene have a melt flow index in the range of 0.05 to 0.2 g/10 min and a density in the range of 0.948 to 0.955 g/cm³; and
(ii) the first and second outermost layers independently (a) comprise a metallocene polyethylene having a melt flow index in the range of 0.5 to 2.5 g/10 min and a density in the range of 0.916 to 0.935 g/cm³, or (b) have a heat seal initiation temperature of no greater than 120° C., wherein at least one of the first and second outermost layers has a heat seal initiation temperature of no greater than 120° C.

In one embodiment, only one of the first and second outermost layers have a heat seal initiation temperature of no greater than 120° C.

In another embodiment, both the first and second outermost layers have a heat seal initiation temperature of no greater than 120° C.

In one embodiment, the heat seal initiation temperature of no greater than 120° C. is provided by a polymer composition comprising a metallocene polyethylene having a melt flow index in the range of 1 to 15 g/10 min and a density in the range of 0.910 to 0.920 g/cm³.

In a further embodiment, the heat seal initiation temperature of no greater than 120° C. is provided by a polymer composition comprising a melt blend of:
(i) metallocene polyethylene having a melt flow index in the range of 1 to 15 g/10 min and a density in the range of 0.910 to 0.920 g/cm³; and
(ii) metallocene polyethylene-co-α-olefin plastomer.

Polymer films in accordance with the invention comprise both polyethylene and starch and yet surprisingly exhibit physical and mechanical properties comparable with polyethylene based films absent starch. In other words, it has now been found that polymer films can be made using both polyethylene and starch components and yet still exhibit desired properties of polyethylene alone. Without wishing to be limited by theory, it is believed that the unique multilayer structure/composition of the films enables the starch component to be combined with polyethylene in a manner which advantageously counteracts the known disadvantages of combining polyethylene and starch. The polymer films can therefore attain advantages afforded by polyethylene resins while still deriving environmental benefits of incorporating renewal content such as starch.

Polymer films in accordance with the invention have been found to exhibit excellent transparency, seal strength, toughness and puncture resistance, the extent of which are noticeably superior to conventional polyethylene/starch based polymer films.

In one embodiment, one or more of the inner and each outermost polymer layers further comprise a pro-degradant. In a further embodiment, each polymer layer in the multilayer structure further comprises a pro-degradant.

Incorporation of a pro-degradant in the polymer film according to the invention enables the film to be manufactured such that it undergoes oxo-degradation in a controlled manner.

In addition to benefits derived by incorporating renewable content such as starch, polymer films in accordance with the invention that comprise pro-degradant present a further advantage in that the films can be designed to degrade at accelerated rates after their consumer lifetime and thereby minimise certain negative impacts upon the film being disposed at land filled sites.

Polymer films in accordance with the invention are particularly well suited for use in the manufacture of bags for containing a consumer product.

In one embodiment, the polymer film is in the form of a bag suitable for containing a consumer product.

In a further embodiment, the bag is heat sealed to contain the consumer product therein.

In another embodiment, the consumer product is in a liquid state.

In yet a further embodiment, the liquid is or comprises water.

In another embodiment, the polymer film is in the form of a sealed bag containing a consumer product.

The present invention also provides a process for producing a sealed bag having a consumer product contained therein, said process comprising bringing the consumer product into contact with polymer film in accordance with the invention and heat sealing the polymer film so as to form the sealed bag containing consumer product.

Those skilled in the art will appreciate that transportation of packaged consumer products can be problematic in terms of at least ensuring the packaging remains sufficiently intact during transport to satisfactorily contain the consumer product. For example, consumer goods packaged in glass containers need to be transported carefully to avoid breakage of the glass and loss of the consumer product. Furthermore, consumer products are often packaged and transported in large rigid containers, for example large rigid plastic containers. While such plastic containers may not be as susceptible to breakage compared with glass containers, they do present practical disposal problems after use at least in part due to their large inherent volume.

Owing at least to its excellent toughness, puncture resistance and sealability, polymer film in accordance with the invention can advantageously be formed into flexible tough and well sealed bags or bladders for containing consumer product. As a result of the bag having flexibility, after being filled with consumer product and subsequently sealed, the packaged consumer product can be stacked for transport such that there is little if no void space between the stacked items. Furthermore, the excellent durability of the well sealed polymer film enables the bags to be handled without concern of rupture and subsequent loss of the consumer product.

In one embodiment, the sealed bag containing consumer product does not rupture upon being dropped from a height of 1 metre onto a concrete substrate.

Bags made from film in accordance with the invention can advantageously be manufactured to contain a large range in volume of consumer product. In one embodiment, the bag is manufactured to contain consumer product at a volume that is up to 500 ml, or up to 1 l, or up to 10 l, or up to 15 l, or up to 20 l, or up to 25 l, or up to 30 l.

In one embodiment, the sealed bag is of a size that accommodates a volume of the consumer product ranging from about 500 ml to about 30 l.

The present invention also provides a process for producing a sealed bag containing consumer product, the process comprising forming a bag using polymer film in accordance with the invention, filling the so formed bag with consumer product and subsequently sealing the bag so as to form the sealed bag containing consumer product.

Where polymer film in accordance with the invention is manufactured into a bag, and that bag is sealed so as to contain consumer product, it may be desirable for that bag itself to be subsequently sealed within another bag so as to form a bag-in-bag arrangement. Such bag-in-bag arrangements can be useful where it is desirable to prevent the inner sealed bag containing consumer product from being exposed to an uncontrolled external and potentially contaminating environment.

In a further embodiment, the sealed bag containing consumer product is itself sealed in a second bag (e.g. in the form of a plastic cover bag). The second bag may or may not be manufactured from polymer film in accordance with the invention.

Further aspects and embodiments of the invention are described in more detail below.

### BRIEF DESCRIPTION OF THE DRAWINGS

The invention will hereinafter be described with reference to the following non-limiting drawings in which:

FIG. 1 illustrates drop test results of multi-layer bags prepared in Example B2;

FIG. 2 illustrates tensile test results of multi-layer bag film prepared in Example B2;

FIG. 3 illustrates elongation at break test results of multi-layer bag film prepared in Example B2;

FIG. 4 illustrates elastic modulus test results of multi-layer bag film prepared in Example B2;

FIG. 5 illustrates dart impact test results of multi-layer bag film prepared in Example B2; and

FIG. 6 illustrates tear test results of multi-layer bag film prepared in Example B2.

### DETAILED DESCRIPTION OF THE INVENTION

The polymer film in accordance with the invention has a multilayer structure, the multilayer structure comprising an inner polymer layer interposed between first and second outermost polymer layers. The multilayer structure can therefore be described as having a “sandwich” or laminated type structure.

By the multilayer structure having “first and second outermost polymer layers” is meant that the first and second outermost polymer layers each represent the last polymer layer in the multilayer structure.

The multilayer structure also comprises an inner polymer layer that is interposed between the first and second outermost polymer layers. The multilayer structure may comprise one or more other inner polymer layers interposed between the first and second outermost polymer layers.

In one embodiment, there is only one inner polymer layer interposed between the first and second outermost polymer layers. In that case, the multilayer film may be described as having a tri-layer structure, the tri-layer structure being made up of the inner polymer layer interposed between the first and second outermost polymer layers.

For convenience only, the inner polymer layer may be referred to herein as a “core layer”, and the first and second outermost polymer layers may be referred to herein simply as first and second polymer layers, respectively.

According to the invention, the inner polymer layer comprises a melt blend of components (a)-(d). By comprising a “melt blend” of components is meant that the components have been melt mixed to afford an integral intimate blend of the components.

It will be appreciated that in the context of the polymer film per se, the expression “melt blend” will generally be used to describe the blend in a solid state. However, those skilled in the art will appreciate that in the context of producing the polymer film the expression “melt blend” may also extend to describe the blend in a molten state.

Component (a) of the inner polymer layer is a starch containing polymer composition comprising polyethylene, thermoplastic starch, and one or more compatibilisers. In the context of producing the polymer film in accordance with the invention, the starch containing polymer composition may itself be provided/used in the form of a physical blend (i.e. a mere admixture) or a melt blend of the constituent components.

Polyethylene used in accordance with this invention will generally be sourced from fossil based petroleum, but, can also be derived from a renewable source, like sugar cane or starches.

In the context of producing the polymer film in accordance with the invention, the starch containing polymer composition (i.e. component (a)) will generally provided/used in the form of a melt blend of the constituent components. Accordingly, the starch containing polymer composition will itself generally be produced in the form of a melt blend in advance of it being melt processed with components (b)-(d) to form the inner polymer layer.

The starch containing polymer composition comprises polyethylene. The type of polyethylene used may be varied depending upon the intended application of the film. For example, the polyethylene may be selected from one or more of very low density polyethylene (VLDPE), low density polyethylene (LDPE), linear low density polyethylene (LLDPE), medium density polyethylene (MDPE), and high density polyethylene (HDPE).

In one embodiment, the starch containing polymer composition comprises VLDPE, which is typically characterised as having a density of less than 0.905 g/cm³. Generally, the VLDPE will have a density ranging from about 0.85 g/cm³ to 0.905 g/cm³, for example from about 0.88 g/cm³ to 0.905 g/cm³. VLDPE is also known in the art as ultra low density polyethylene (ULDPE), and is generally a copolymer of ethylene and one or more α-olefins such as 1-butene, 1-hexene, and 1-octene.

The VLDPE used will generally have a melt flow index of about 0.5 g/10 min to about 10 g/10 min.

Reference herein to a density or melt flow index (MFI) is intended to mean a density determined in accordance with ASTM D792 and a melt flow index determined in accordance with and ASTM D1238. MFI is intended to be that measured at 190° C./2.16 kg.

Suitable VLDPE includes, but is not limited to, an ethylene/octene copolymer having a density of about 0.904 g/cm³ and a melt flow index of about 4 g/10 min, an ethylene/butene copolymer having a density of about 0.884 g/cm³ and a melt flow index of about 0.7 g/10 min, and an ethylene/butene copolymer having a density of about 0.8985 g/cm³ and a melt flow index of about 5 g/10 min.

The use of VLDPE in the starch containing polymer composition is believed to facilitate compatibilisation of at least the components present in that composition and those in the inner polymer layer.

LDPE is generally characterised as having a density in the range of 0.910 g/cm³ to 0.940 g/cm³. LDPE that may be used includes, but is not limited to, that having a melt flow index of about 0.2 g/10 min to about 7 g/10 min.

In one embodiment of the invention, the starch containing polymer composition comprises VLDPE and LDPE.

LLDPE is generally characterised as having a density ranging from 0.910 g/cm³ to 0.926 g/cm³, MDPE is generally characterised as having a density ranging from 0.926 g/cm³ to 0.940 g/cm³, and HDPE is generally characterised as having a density of at least 0.941 g/cm³ (typically 0.941 g/cm³ to 0.965 g/cm³).

Suitable grades of VLDPE, LDPE, LLDPE, MDPE and HDPE may be obtained commercially.

The polyethylene used in the starch containing polymer composition will generally be present in an amount ranging from about 5 wt % to about 85 wt %, relative to the other components present in that composition. In one embodiment, the polyethylene within the starch containing polymer composition is present in an amount ranging from about 5 wt % to about 65 wt %, for example about 5 wt % to about 45 wt % or from about 5 wt % to about 25 wt %, relative to the other components present in the composition.

In another embodiment of the invention, the total polyethylene content in the starch containing polymer composition is made up of about 1 wt % to about 10 wt % VLDPE and about 90 wt % to about 99 wt % LDPE.

The starch containing polymer composition also comprises compatibiliser. As used herein, the term “compatibiliser” is intended to mean an agent that will facilitate compatibilisation of polyethylene and thermoplastic starch (TPS). Those skilled in the art will appreciate that polyethylene and TPS are inherently incompatible with each other and upon being melt processed together will give rise to a multi-phase morphology having a high interfacial tension. In that context, a compatibiliser facilitates a reduction of the interfacial tension of the multi-phase morphology to provide for a more homogeneous morphology. Such compatibilisers will typically exhibit amphipathic character in that they will have a molecular structure which presents both hydrophilic and hydrophobic regions. For convenience, the compatibiliser may therefore be described as being an amphipathic compatibiliser.

Examples of suitable compatibilisers include, but are not limited to, ethylene acrylic acid copolymer (EAA), ethylene methacrylic acid copolymer (EMA), polyethylene-co-vinyl acetate (EVA), polyethylene-co-vinyl alcohol (EVOH), graft copolymer of polyethylene and maleic anhydride, and ionomer (e.g. polymer having acid functional groups where at least some of the acid groups are neutralised by a metal cation such as zinc, sodium or lithium).

Compatibiliser suitable for use in accordance with the invention may be obtained commercially.

The compatibiliser will generally be used in an amount ranging from about 2 wt % to about 25 wt %, or about 2 wt % to about 20 wt %, or about 2 wt % to about 15 wt %, or about 5 wt % to about 15 wt %, relative to the total mass of components present in the starch containing polymer composition.

In one embodiment, the compatibiliser is EAA. Generally, the EAA used will have an acrylic acid content in the range from about 5% to about 20%, for example from about 8% to about 15%. The EAA used will also generally have a melt flow index ranging from about 10 g/10 min to about 20 g/10 min.

The starch containing polymer composition of course also comprises a starch component in the form of TPS. Those skilled in the art will appreciate that TPS is a destructured form of starch comprising one or more plasticisers.

Starch is found chiefly in seeds, fruits, tubers, roots and stem pith of plants, and is a naturally derived polymer made up of repeating glucose groups linked by glucosidic linkages in the 1-4 carbon positions. Starch consists of two types of alpha-D-glucose polymers: amylose, a substantially linear polymer with molecular weight of about 1×10⁵; and amylopectin, a highly branched polymer with very high molecular weight of the order 1×10⁷. Each repeating glucose unit typically has three free hydroxyl groups, thereby providing the polymer with hydrophilic properties and reactive functional groups. Most starches contain 20 to 30% amylose and 70 to 80% amylopectin. However, depending on the origin of the starch the ratio of amylose to amylopectin can vary significantly. For example, some corn hybrids provide starch with 100% amylopectin (waxy corn starch), or progressively higher amylose content ranging from 50 to 95%.

Starch typically exists in small granules having a crystallinity ranging from about 15% to 45%. The size of the granules may vary depending upon the origin of the starch. For example, corn starch typically has a particle size diameter ranging from about 5 μm to about 40 μm, whereas potato starch typically has a particle size diameter ranging from about 50 μm to about 100 μm.

This “native” or “natural” form of starch may also be chemically modified. Chemically modified starch includes, but is not limited to, oxidised starch, etherificated starch, esterified starch, cross-linked starch or a combination of such chemical modifications (e.g. etherificated and esterified starch). Chemically modified starch is generally prepared by reacting the hydroxyl groups of starch with one or more reagents. The degree of reaction, often referred to as the degree of substitution (DS), can significantly alter the physiochemical properties of the modified starch compared with the corresponding native starch. The DS for a native starch is designated as 0 and can range up to 3 for a fully substituted modified starch. Depending upon the type of substituent and the DS, a chemically modified starch can exhibit considerably different hydrophilic/hydrophobic character relative to native starch.

Both native and chemically modified starch generally exhibit poor thermoplastic properties. To improve such properties, the starch may be converted to TPS by means well known in the art. For example, native or chemically modified starch may be melt processed with one or more plasticisers. Polyhydric alcohols are generally used as plasticisers in the manufacture of TPS.

Reference herein to a wt % of TPS is therefore intended to include the collective mass of both the starch and plasticiser constituent components of TPS.

The starch from which the TPS may be derived includes, but is not limited to, corn starch, potato starch, wheat starch, soy bean starch, tapioca starch, hi-amylose starch or combinations thereof.

Where the starch is chemically modified, it will generally be etherificated or esterified. Suitable etherificated starches include, but are not limited to, those which are substituted with ethyl and/or propyl groups. Suitable esterified starches include, but are not limited to, those that are substituted with acetyl, propanoyl and/or butanoyl groups.

In one embodiment of the invention, the starch used to prepare the TPS is native starch, for example native starch selected from one or more of corn starch, potato starch, wheat starch, soy bean starch, tapioca starch, and hi-amylose starch.

In another embodiment of the invention, the starch used to prepare the TPS is corn starch or corn starch acetate having a DS>0.1.

The TPS will generally also comprise one or more polyhydric alcohol plasticisers. Suitable polyhydric alcohols include, but are not limited to glycerol, one or more of ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neo-pentyl glycol, trimethylol propane, pentaerythritol, sorbitol, mannitol and the acetate, ethoxylate, and propoxylate derivatives thereof.

In one embodiment, the TPS comprises glycerol and/or sorbitol plasticisers.

The plasticiser content of the TPS will generally range from about 5 wt % to about 50 wt %, for example from about 10 wt % to about 40 wt %, or from about 10 wt % to about 30 wt %, relative to the combined mass of the starch and plasticiser component(s).

The TPS will generally be present in the starch containing polymer composition in an amount ranging from about 10 wt % to about 80 wt %, relative to the total mass of all components present in the composition. In one embodiment, the TPS is present within the starch containing polymer composition in an amount ranging from about 30 wt % to about 75 wt %, for example from about 50 wt % to about 75 wt % or from about 60 wt % to about 75 wt %, relative to the total mass of all components present in the composition.

In one embodiment, the starch containing polymer composition comprises polyethylene in an amount ranging from about 5 wt % to about 85 wt %, compatibiliser in an amount ranging from about 2 wt % to about 25 wt %, and TPS in an amount ranging from about 10 wt % to about 80 wt %, relative to the total mass of all components present in the composition.

In a further embodiment, the starch containing polymer composition comprises polyethylene in an amount ranging from about 5 wt % to about 25 wt %, compatibiliser in an amount ranging from about 5 wt % to about 15 wt %, and TPS in an amount ranging from about 50 wt % to about 75 wt %, relative to the total mass of all components present in the composition.

Without wishing to be limited by theory, it is believed that the starch containing polymer composition provides for a highly compatibilised blend of polyethylene and TPS. In particular, it is believed that at least the TPS and polyethylene phase domains can be provided with a co-continuous morphology due to the function of the compatibiliser. By “co-continuous phase morphology” in the context of the TPS and polyethylene phase domains in at least a melt blend form of component (a) is intended to mean the topological condition in which a continuous path through either phase domain may be drawn to all phase domain boundaries without crossing any phase domain boundary.

In addition to a primary compatibiliser such as EAA, the starch containing polymer composition may further comprise one or more co-compatibilisers such as EVA. In that case, the one or more co-compatibilisers will generally be present in an amount ranging from about 0.2 wt % to about 2 wt %, relative to the total mass of all components present in the composition.

The starch containing polymer composition in accordance with the invention may also comprise polyolefin wax. The expression “polyolefin wax” is intended to mean a low molecular weight polyolefin. By “low” molecular weight is mean a number average molecular weight (Mn) of less than about 5000, less than about 4000, or less than about 3000.

Reference herein to molecular weight (Mn) is that as measured by gel permeation chromatography (GPC).

The polyolefin wax will generally be prepared by thermal or chemical degradation of a polyolefin or from the partial polymerisation (i.e. oligomerisation) of olefins.

In one embodiment, the polyolefin wax has a number average molecular weight (Mn) ranging from about 250 to about 3500.

The polyolefin wax will generally be a homopolymer or copolymer of ethene, propene and one or more other α-olefins.

In one embodiment, the polyolefin wax is a polyethylene wax.

For avoidance of any doubt, where the polyolefin wax is a polyethylene wax, the “polyethylene wax” should not be considered as part of the “polyethylene” content of the starch containing polymer composition. In other words, the polyethylene content of the starch containing polymer composition is not intended to embrace any polyethylene wax that may also be present in the composition.

The polyolefin wax may also be substituted with one or more polar moieties. For example, the polyolefin wax may be an oxidized polyolefin wax.

In one embodiment, the polyolefin wax has an MFI ranging from about 2000 to about 4000 g/10 min, or about 2500 to about 3500 g/10 min, or about 2750 to about 3250 g/10 min, or about 3000 g/10 min.

In another embodiment, the polyolefin wax has a melting point or melting range greater than about 95° C.

In a further embodiment, the polyolefin wax has a melting point or melting range falling within the temperature range of about 95° C. to about 120° C.

Reference to the melting point or melting range of the polyolefin wax herein is that measured by Differential Scanning calorimetry (DSC) at a heat rate of 10° C./min according to ASTM 3417.

When used, the polyolefin wax will generally be present in an amount ranging from about 0.2 wt % to about 2 wt %, or about 0.2 wt % to about 1 wt %, relative to the total mass of all components present in the composition.

The starch containing polymer composition may also comprise one or more additives. Such additives may include fillers (e.g. calcium carbonate, talc, clays (e.g. montmorillonite) and titanium dioxide); pigments; anti-static agents; and processing aids e.g. calcium stearate, steric acid, magnesium stearate, sodium stearate, oleamide, stearamide and erucamide.

If used, such additives will generally be present in amount ranging from about 0.1 wt % to about 0.4 wt %, relative to the total mass of all components present in the composition.

In addition to the starch containing polymer composition, the inner polymer layer of the multilayer structure further comprises component (b), being a metallocene polyethylene having a melt flow index in the range of 0.5 to 2.5 g/10 min and a density in the range of 0.910 to 0.935 g/cm³.

Those skilled in the art will appreciate that a “metallocene” polyethylene is polyethylene that has been manufactured using a metallocene catalyst. Metallocene polyethylene resins are available commercially.

In one embodiment, the metallocene polyethylene used in component (b) is metallocene LLDPE (mLLDPE).

Component (c) of the inner polymer layer is polyethylene having a melt flow index in the range of 2 to 4 g/10 min and a density in the range of 0.918 to 0.925 g/cm³. This polyethylene may be further described as being LDPE.

The inner polymer layer further comprises component (d), namely polyethylene having a melt flow index in the range of 0.05 to 0.2 g/10 min and a density in the range of 0.948 to 0.955 g/cm³. This polyethylene may be further described as HDPE.

Components (a)-(d) of the inner polymer layer are provided in the form of a melt blend. To provide the melt blend, components (a)-(d) will generally be melt processed. Components (a)-(d) may be melt processed together to form the inner layer polymer composition in advance, or at the time, of forming the polymer film. As previously noted, component (a) may itself be used in the form of a melt blend that has been formed in advance, or at the time, of forming the inner polymer layer melt blend.

Conventional melt processing equipment may be used to prepare the inner polymer layer melt blend. For example, the melt blend may be prepared using conventional extrusion equipment.

Further detail on techniques for producing the melt blend of relevant components is outlined below.

The inner polymer layer will generally comprise component (a) in an amount ranging from about 20 wt % to about 70 wt %, component (b) in an amount ranging from about 20 wt % to about 50 wt %, component (c) in an amount ranging from about 5 wt % to about 35 wt %, and component (d) in an amount ranging from about 5 wt % to about 25 wt %, relative to the total mass of all components present in the inner polymer layer.

The multilayer structure of the polymer film in accordance with the invention further comprises first and second outermost polymer layers. The first and second outermost layers independently (a) comprise a metallocene polyethylene having a melt flow index in the range of 0.5 to 2.5 g/10 min and a density in the range of 0.916 to 0.935 g/cm³, or (b) have a heat seal initiation temperature of no greater than 120° C., wherein at least one of the first and second outermost layers has a heat seal initiation temperature of no greater than 120° C.

In one embodiment, only one of the first and second outermost layers have a heat seal initiation temperature of no greater than 120° C.

In another embodiment, both the first and second outermost layers have a heat seal initiation temperature of no greater than 120° C.

An outermost polymer layer that comprises a metallocene polyethylene having a melt flow index in the range of 0.5 to 2.5 g/10 min and a density in the range of 0.916 to 0.935 g/cm³ may also exhibit a heat seal initiation temperature of no greater than 120° C.

Metallocene polyethylene used in an outermost layer may be obtained commercially.

If desired, an outermost layer may comprise one or more other components such as a colouring agent to colour that layer. Such one or more other components will generally be present in an amount ranging from 0 wt % to about 5 wt %, relative to the total mass of all components present in that layer.

When used, the metallocene polyethylene in an outermost layer will generally be present in an amount ranging from about 95 wt % to 100 wt %, relative to the total mass of all components present in that layer.

At least one of the outermost polymer layers has a heat seal initiation temperature of no greater than 120° C. By a layer having a “heat seal initiation temperature” of no greater than 120° C. is meant that the minimum temperature required to produce a seal of appropriate strength is no greater than 120° C. Heat seal initiation temperature is determined using a “hot tack tester” according to ASTM F-1921-Hot tack-Hot seal strength testing of thermoplastics-method B. Hot tack measures the strength of heat seals formed between thermoplastic surfaces of flexible webs, immediately after the seal has been made and before it cools to room temperature as a function of sealing temperature.

An outermost polymer layer having a heat seal initiation temperature of no greater than 120° C. will generally have a heat seal initiation temperature in the range of about 70° C. up to 120° C.

In one embodiment, the heat seal initiation temperature of no greater than 120° C. is provided by a polymer composition comprising one or more of metallocene polyethylene having a melt flow index in the range of 1 to 15 g/10 min and a density in the range of 0.910 to 0.920 g/cm³, metallocene polyethylene-co-α-olefin plastomer, for example metallocene polyethylene-co-α-olefin plastomer having a melt flow index in the range of 2 to 30 g/10 min and a density in the range of 0.850 to 0.910 g/cm³, ethylene acrylic acid copolymer (EAA), ethylene methacrylic acid copolymer (EMA), polyethylene-co-vinyl acetate (EVA), polyethylene-co-vinyl alcohol (EVOH), graft copolymer of polyethylene and maleic anhydride, and ionomer (e.g. polymer having acid functional groups where at least some of the acid groups are neutralised by a metal cation such as zinc, sodium or lithium).

In another embodiment, the heat seal initiation temperature of no greater than 120° C. is provided by a polymer composition comprising a metallocene polyethylene having a melt flow index in the range of 1 to 15 g/10 min and a density in the range of 0.910 to 0.920 g/cm³.

In a further embodiment, the heat seal initiation temperature of no greater than 120° C. is provided by a polymer composition comprising a melt blend of:
(e) metallocene polyethylene having a melt flow index in the range of 1 to 15 g/10 min and a density in the range of 0.910 to 0.920 g/cm³; and
(f) metallocene polyethylene-co-α-olefin plastomer.

An outermost layer of the multilayer structure may therefore comprise a melt blend of components (e) and (f).

Metallocene polyethylene having a melt flow index in the range of 1 to 15 g/10 min and a density in the range of 0.910 to 0.920 g/cm³ (i.e. Component (e)) is available commercially.

Where an outermost layer comprises component (f), namely metallocene polyethylene-co-α-olefin plastomer, the plastomer will generally have a melt flow index in the range of 2 to 50 g/10 min and a density in the range of 0.850 to 0.91 g/cm³.

By “metallocene polyethylene-co-α-olefin plastomer” is meant a copolymer of ethylene and one or more alkenes polymerised using a metallocene catalyst. Plastomers suitable for use in accordance with the invention are typically copolymers of ethylene and α-olefins having 3 to 10 carbon atoms such as propylene, 1-butene, 1-hexene, and 1-octene. Such plastomers are commercially available from DuPont/Dow elastomers, under the trademark ENGAGE®, Dow Plastics under the trademark Affinity® and from ExxonMobil Chemicals under trademarks EXACT® and Vistamaxx®.

In one embodiment, suitable metallocene polyethylene-co-α-olefin plastomers include those where the α-olefin comonomer is a C₃ to C₁₂ α-olefin or mixture of such α-olefins. In a further embodiment, C₃, C₄, C₆ and/or C₈ α-olefin comonomers are used.

When present as a melt blend with component (e), the metallocene polyethylene co-α-olefin plastomer (component (f)) may be used in an amount up to 50 wt %, relative to the total of all components present in the second outermost layer.

When used, component (e) will generally be present in an outermost layer in an amount ranging from about 50 wt % to about 100 wt %, relative to the total amount of all components present in that layer.

An outermost polymer layer having a heat seal initiation temperature of no greater than 120° C. may be used to facilitate formation of a sealed bag made from the film. The manner in which a given bag structure is manufactured may require one or both of the outermost layers of the film to have a heat seal initiation temperature of no greater than 120° C. Those skilled in the art will select an appropriately designed film to manufacture a given bag structure.

Each layer that makes up the multilayer structure of the polymer film according to the invention may further comprise a pro-degradant. In that case, the pro-degradant will generally be present in an amount ranging from about 0.5 wt % to about 2 wt %, relative to the total mass of all components in a given layer. For example, each of the inner polymer layer and the first and second outermost polymer layers may comprise about 0.5 to about 2 wt % of pro-degradant.

Pro-degradants are agents known in the art that can accelerate the degradation of polymer such as polyethylene.

Those skilled in the art will appreciate that in the context of a pro-degradant/polymer composition the term “degradation” is intended to mean that a polymer product comprising pro-degradant can undergo embrittlement followed by fragmentation or comminution due to a reduction in the polymers molecular weight. Such degradation is also known in the art as oxo-degradation and it is not to be confused with biodegradation which requires the action of microorganisms.

Accordingly, upon undergoing oxo-degradation the physical properties of the polymer are reduced and products made from it become embrittled to a point where they can readily fragment into small pieces. The resulting comminuted degraded product advantageously presents a reduced volume and consequently has reduced negative land fill impact. Also, comminution of the product renders the polymer more susceptible over time to bioassimilation through biodegradation.

For convenience, the terms “degradation”, “degrade” “degraded” or grammatical variations thereof may be used interchangeably herein with the terms “oxo-degradation”, “oxo-degrade”, “oxo-degraded” or grammatical variations thereof.

Those skilled in the art will also appreciate that oxo-degradation of a polymer is a process that can occur continuously in the presence or absence of a pro-degradant. However, it is the degree and rate at which oxo-degradation occurs that is important in the context of using a pro-degradant in the present invention.

Use of a pro-degradant in accordance with the invention serves to accelerate the degree and rate of oxo-degradation relative to the relevant polymer composition in the absence of the pro-degradant. Given that polymers such as polyethylene can take hundreds of years to degrade under standard environmental conditions, use of the pro-degradant in accordance with the invention enables degradation of the polymer films to occur at a desired and controlled practical point in time after manufacture.

A common definition in the art for the period of time in which a polymer product has useful service lifetime is the period in which the tensile strength of the product, as measured according to ISO 527-3 remains at least 50% of the original tensile strength of the product. Alternatively, a polymer product is also referred to in the art as having reached its useful lifetime when its elongation to brake, as measured by ASTM D638; type IV dumbbell is less than 5% and/or the product has a carbonyl index greater than or equal to 0.10, as measured using infrared spectroscopy using the ratio of absorbance peaks at 1465 and 1755.

Polymer film according to the invention comprising pro-degradant will therefore be designed and sold with a particular useful lifetime in mind. In other words, the film will generally be sold with a “use by” date. This useful lifetime will largely depend on the amount of pro-degradant in the film.

Those skilled in the art can readily formulate a polymer film according to the invention to meet the useful lifetime requirements of a given consumer product. For example, a series of trial compositions can be prepared using different concentrations of pro-degradant. Film made from such compositions can be subjected to accelerated aging (e.g. in an oven at 80° C. for 1 week). The film properties can then be tested and the results extrapolated (if need be) to determine the appropriate concentration of pro-degradant to achieve the desired useful lifetime.

There is no particular limitation regarding the type of pro-degradant that may be used in accordance with the invention.

The prodegradant may be a metal salt. The metal salt may include a metal selected from cobalt, cerium, iron, aluminum, antimony, barium, bismuth, cadmium, chromium, copper, gallium, lanthanum, lead, lithium, magnesium, mercury, molybdenum, nickel, potassium, rare earths, silver, sodium, strontium, tin, tungsten, vanadium, yttrium, zinc or zirconium.

In one embodiment the prodegradant is a metal carboxylate.

Examples of suitable prodegradants include cobalt acetate, cobalt stearate, cobalt octoate, cobalt napthenate, iron napthenate, iron octoate, iron stearate, lead stearate, lead octoate, zirconium stearate, cerium stearate, cerium octoate, manganous stearate, manganous oleate, manganous dodecyl acetoacetate, cobalt acetyl acetonate, cobaltous acetate, cobaltous oleate, cobaltous stearate, cobaltous dodecyl acetoacetate, cupric stearate, cupric oleate, ferric acetate, zinc octoate, zinc napthenate, iron distearate, potassium permanganate, potassium trioxalatocobaltate (III), tris(ethylenediamine)cobalt (III) chloride, sodium hexanitrocobaltate (III), potassium hexacyanocobaltate (III) and combinations thereof.

To assist with tailoring polymer film in accordance with the invention to provide for a product with a specified useful lifetime, the composition may further comprise one or more oxidation inhibiting agents. Such agents can serve to inhibit oxo-degradation of the polyolefin through various mechanisms such as minimising the formation of carbon centred radicals on the polyolefin backbone (e.g. using UV absorbers), radical scavenging (e.g. using hindered amines and/or phenolic antioxidants), and non-radical decomposition of hydroperoxide species (e.g. using organic phosphites). The agents can therefore be used in conjunction with the pro-degradant to more precisely control the degradation profile of the film.

Examples of suitable oxidation inhibiting agents include phenolic antioxidants, radical scavenges, organic phosphites, and UV absorbers.

Specific examples of phenolic antioxidants and radical scavengers include Irganox 1010, pentaerythritol tetrakis(3-(3,5-di-tert-butyl-4-hydroxyphenyl)propionate), Irganox 1076, octadecyl 3-(3,5-di-tert-butyl-4-hydroxyphenyl)propionate, and Hostanox 03, ethylene bis[3,3-bis(3-tert-butyl-4-hydroxyphenyl)butyrate].

Specific examples of organic phosphites include Irgafos 168, Tris(2,4-di-tert-butylphenyl)phosphite, Weston TNPP, Tris(nonylphenyl)phosphite and Weston 705, Nonylphenol-free Phosphite.

Specific examples of UV absorbers include Tinuvin 770, Bis(2,2,6,6-Tetramethyl-4-Piperidinyl)sebacate, and Chimassorb 944, Poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2, 2,6,6-tetramethyl-4-piperidinyl)imino]].

The amount of oxidation inhibiting agent used will vary depending upon the amount of pro-degradant used. If used, an oxidation inhibiting agent will be present in an amount ranging from about 0.01 wt. % to about 4 wt. %, for example ranging from about 0.01 wt. % to about 2 wt. %, ranging from about 0.01 wt. % to about 1 wt. %, relative to the total mass of all components present in the relevant layer of the film.

Polymer film in accordance with the invention may also comprise one or more additives. Such additives may include fillers (e.g. calcium carbonate, talc, clays (e.g. montmorillonite), and titanium dioxide); pigments; anti-static agents; and processing aids (e.g. calcium stearate, steric acid, magnesium stearate, sodium stearate, oxidised polyethylene, oleamide, stearamide and erucamide).

If used, such additives will generally be present in an amount ranging from about 0.5 wt. % to about 2 wt. %, relative to the total mass of all components present in the relevant layer of the film.

In one embodiment, an antistatic additive is present in/incorporated into the first and second outermost polymer layers. Suitable antistatic agents include quaternary ammonium antistatic agents. The antistatic additives may be present/used in an amount ranging from about 0.1 wt % to about 0.4 wt %, relative to the total mass of all components present in the relevant layer of the film.

Depending on the application of the polymer film, it may be particularly desirable to incorporate an anti-blocking and/or slip agent as an additive in at least the first and second outermost polymer layers.

In one embodiment, an anti-blocking and/or slip additive is incorporated into each of the first and second outermost polymer layers.

Suitable slip additives include migratory slip additives (e.g. oleamide, stearamide or erucamide) and non-migratory slip additives (e.g. polysiloxanes).

Suitable anti-blocking additives include calcium carbonate, talc, clays (e.g. montmorillonite) and silica.

The anti-blocking and/or slip additive may be present/used in an amount ranging from about 0.1 wt % to about 2 wt %, relative to the total mass of all components present in the relevant layer of the film.

Polymer film in accordance with the invention is prepared by a process that comprises forming the multilayer structure by co-extruding the inner polymer layer interposed between the first and second outermost polymer layers. Conventional co-extrusion equipment and techniques can advantageously be used to produce the structure. Generally, the multilayer structure will be produced by multi-layer cast or blown film co-extrusion.

Each of the polymer layers that make up the multilayer structure comprise, or may comprise, more than one component. Where a given polymer layer does comprise more than one component the individual components may be combined at the time of producing the polymer film. Alternatively, one or more of the components may be combined in advance of producing the film and optionally melt processed so as to form a melt blend of the two or more components. In that case, the melt blend of the two or more components can be stored and subsequently used in the process of producing the polymer film. For example, for the inner polymer layer comprising a melt blend of components (a)-(d), component (a) may be provided in the form of a melt blend that has been prepared in advance which is subsequently combined at the time of forming the film with components (b)-(d).

Where two or more components present in a given polymer layer of the polymer film are combined and melt processed in advance of producing the polymer film, this melt processing may be performed using techniques and equipments well known in the art. Generally, melt processing is achieved using conventional extrusion equipment, such as single screw extruders, twin screw extruders, other multiple screw extruders or Farrell continuous mixers. Melt processing is conducted for sufficient time and a suitable temperature to promote intimate melt blending between the components being combined. Those skilled in the art will appreciate that melt processing is generally performed within a suitable temperature range and that this range will vary depending upon the nature of the components being melt processed. Generally, components used in accordance with the invention will be melt processed at temperatures ranging from about 150° C. to about 210° C.

As used herein, the term “extrusion”, or its variants such as “extruder”, “extrudes”, “extruding”, etc, is intended to define a process of forcing molten polymer through a forming die.

Generally, co-extrusion of the inner polymer layer interposed between the first and second outermost polymer layers according to the process of the invention will comprise feeding by extrusion the respective polymer melt streams into a die such as a slot die or an annular die so as to combine the melt streams into at least a tri-layer structure of the appropriate construction. The resulting multi-layer structure is then typically rapidly quenched and stretched so as to form a multilayer film. Additional polymer melt streams may of course also be introduced to the die to increase the number of layers of the resulting film. In that case, such layers will of course need to be further inner polymer layers as the polymer film must have the stated first and second polymer layers as the respective outermost polymer layers.

There is no particular limitation concerning the thickness of each layer that makes up the multilayer structure of the polymer film. For example, the thickness of the inner polymer layer may range from about 8 μm to about 120 μm, for example from about 30 μm to about 50 μm.

Each of the first and second outermost polymer layers may be of the same or different thickness. Generally, the first and second outermost polymer layers will have a similar or substantially the same thickness.

In one embodiment, the first and second outermost polymer layers each have a thickness independently ranging from about 8 μm to about 15 μm, for example from about 15 μm to about 35 μm.

In a further embodiment, the inner polymer layer represents about 40 wt % to about 80 wt %, and each of the first and second outermost polymer layers independently represent about 10 wt % to about 30 wt %, of the total mass of the polymer film.

In certain applications it may be desirable that the polymer film is suitable for use in food contact applications. In that case, at least the outermost polymer layer in contact with the food source should be food contact compliant.

Accordingly, in one embodiment, at least one of the outermost polymer layers is food contact compliant.

In a further embodiment, at least the first and second outermost polymer layers are each food contact compliant.

By being “food contact compliant” is meant compliance with EU Regulation No 10/2011. According to this regulation, plastic materials or articles should not transfer their constituents to food stuffs in quantities exceeding the overall migration limit of 60 mg/kg (by weight of food stuff) or 10 mg/dm² (by surface area of the article or material).

Polymer films in accordance with the invention can advantageously comprise both polyethylene and starch and yet surprisingly exhibit physical and mechanical properties comparable with polyethylene based films absent starch. Such properties make the films particularly well suited to use in the manufacture of bags for containing consumer product.

Accordingly, in one embodiment the polymer film is in the form of a bag suitable for containing a consumer product.

In another embodiment, the consumer product is intended for animal or human consumption.

There is no particular limitation on the manner in which polymer film in accordance with the invention may be manufactured into a bag suitable for containing consumer product.

Techniques and equipment for converting polymer film into such bags are well known in the art and can advantageously be used with the polymer film according to the invention.

Polymer film in accordance with the invention is also particularly well suited for use in the manufacture of bags for containing consumer product using a form, fill and seal process.

Accordingly, the present invention further provides a process for producing a sealed bag containing consumer product, the process comprising forming a bag using polymer film in accordance with the invention, filling the so formed bag with consumer product and subsequently sealing the bag so as to form the sealed bag containing consumer product.

Those skilled in the art will appreciate that form, fill and seal processes are known in the art for producing sealed bags containing consumer product. Conventional form, fill and seal equipment and techniques can conveniently be used in producing sealed bags containing consumer product according to the invention.

Polymer film in accordance with the invention includes an outermost layer having a heat seal initiation temperature no greater than 120° C. Bags formed from polymer film according to the invention will therefore generally present such a layer as the inner layer of the bag structure so that the bag can readily be sealed. Sealed bags containing consumer product in accordance with the invention will generally be heat sealed.

In one embodiment, the consumer product contained within the sealed bag is a food or drink product fit for animal or human consumption.

In another embodiment, the consumer product contained within the sealed bag is in a liquid state.

In a further embodiment, the consumer product contained within the sealed bag is or comprises water in a liquid state.

Due to at least its excellent toughness, puncture resistance and sealability, polymer film in accordance with the invention can advantageously be formed into flexible, tough and well sealed bags or bladders for containing consumer product. Such bags or bladders are particularly well suited for containing liquid consumer product such as water. In particular, sealed bags containing consumer product in accordance with the invention are particularly durable, readily transported and can be handled without concern of rupture and the subsequent loss of the consumer product.

In one embodiment, the sealed bag containing consumer product does not rupture upon being dropped from the height of 1 m, or 2 m or 3 m or even 4 m onto a concrete substrate.

Sealed bags containing consumer product in accordance with the invention can advantageously be manufactured to contain a large volume range of consumer product. In one embodiment, the sealed bag is manufactured to contain consumer product having a volume in the range of about 500 ml up to about 30 litres.

In certain applications, it may be desirable that a sealed bag containing consumer product is transported in a manner such that the sealed bag remains substantially free from contaminants that may be derived from, for example, human handling, storage environment, atmospheric pollution etc. In that case, the sealed bag containing consumer product may itself be sealed within another bag so as to form a bag-in-bag arrangement.

By providing the sealed bag containing consumer product in a bag-in-bag arrangement, the entire bag-in-bag arrangement can still be readily transported to a desired location, during which time any contamination will deposit on the outer bag of the arrangement and not on the inner sealed bag containing consumer product. Upon arrival at the desired destination, the bag-in-bag arrangement can, if desired, be stored for subsequent use. At the time when the consumer product is ready to be used, the outer protective bag may be removed to reveal the inner sealed bag containing consumer product having being protected since manufacture from the outer bag arrangement. The inner sealed bag containing consumer product will be substantially free from undesirable contaminants and can be used immediately without any need for cleaning.

A practical example of employing such a bag-in-bag arrangement might be in the transport of potable water. In that case, the sealed bag may contain, for example, 25 litres of potable water. At the point of manufacture the sealed bag containing the water is sealed within another bag so as to form the bag-in-bag arrangement. This bag-in-bag arrangement is then transported to a desired location and optionally stored for subsequent use. At the time when the water is required for use, the outer bag of the bag-in-bag arrangement may be removed so as to reveal the sealed bag containing the water. This sealed bag may then, for example, be deposited into a water dispensing apparatus whereby the sealed bag is pierced so as to release the for use. Both the outer bag of the bag-in-bag arrangement and the inner sealed bag can subsequently be readily disposed of via conventional means.

Where a sealed bag containing consumer product is sealed within another bag so as to form a bag-in-bag arrangement, there is no particular limitation on the nature of the material used to produce the outer bag. The outer or second bag in such an arrangement may or may not be produced from polymer film in accordance with the invention.

In one embodiment, the sealed bag containing consumer product according to the invention is itself sealed within a second bag. In a further embodiment the second bag is manufactured from polymer film in accordance with the invention.

Embodiments of the invention are further described with reference to the following non-examples.

### Examples

### Part A

### Preparation of a Starch Containing Polymer Composition

50 kg of corn starch having a water content of less than 1 wt. %, 12 kg of glycerol, 10 kg of sorbitol, 18 kg of ethylene acrylic acid (EAA) (9% acid, melt flow index=20), 10 kg VLLDPE (Dowlex 9004, 2 g/10 mins.), 7 kg LDPE (MFI>0.5 g/10 mins), 0.7 kg calcium stearate and 0.3 kg stearic acid were melt mixed in a ZSK-65 Twin Screw Extruder (L/D=48). Prior to melt mixing these components, the solid materials were dry blended first in a high speed mixer and the liquid materials then added to provide for a uniform distribution of all components. The temperature profile of the extruder was set at 100° C./130° C./160° C./160° C./150° C./140° C. The rotation speed of the screw was set at 300 rpm. A vacuum of −0.06 to −0.08 bar was applied during extrusion. The composition melt was extruded as a strand, air cooled and cut into pellets.

### Part B

### Preparation of Film Using the Starch Containing Polymer Composition of Part a

### Part B1—Monolayer Film (Comparative)

### Part B1-a—Film Preparation

The following polymer composition (40 wt % LDJ225 (Qenos); 33 wt % Elite 5500G (Dow) 8 wt % HDF895 (Qenos); 15 wt % concentrate from part A and 4 wt % processing aid masterbatch) was dry blended and then blown into 75 micron thick film on a standard LDPE blown film line with an extruder of 65 mm diameter, GP screw, smooth barrel, L/D 30:1, Die gap=1.6 mm and process temperatures: Z1: 150° C., Z2: 180° C., Z3: 180, A: 180° C., Die: 175° C. The melt temperature was kept below about 190° C. to minimise starch decomposition and discoloration. The processing conditions for film blowing were: extruder speed of 35 rpm, line speed of 50 m/min, bubble height of 4.5 m and blow-up ratio of 3:1.

### Part B1-b—Bag Preparation

A vertical form fill and seal machine, type KN3000, manufactured by BiB Packaging, Canada, was used to form a bag, fill it with 101 of drinking water and seal it using the film made as per Part B1-a. The process uses impulse heaters to form the seals at 210-240° C. sealing temperature, a sealing time of 1-1.5 seconds and a cycle time of 10-15 seconds.

### Part B1-c—Bag Performance

Water filled bags as per Part B1-b were tested using a simple drop test onto concrete from height in 1 meter increments up to 4 meters and subsequently inspected for tears, ruptures and leakages. Water filled bags produced as per Part B1-b resulted in a high proportion of leakages at the seal and failed a drop test at 1 meter height. Adjusting the seal parameters temperature, dwell time and pressure did not result in a better performance.

### Part B2—Multi-Layer Film

### Part B2-a—Multi-Layer Film Preparation

Multilayer films were prepared on a conventional 3 layer blown film line. All ingredients were dry blended before feeding them into the hopper of the extruders. Polymer resins/compositions used in the production of the multilayer films are presented below in Table 1.

TABLE 1
Polymer resins/compositions used in the production of the
multilayer films.

| | | | Melt Index | Density |
|---|---|---|---|---|
| Type | Grade | Supplier | (190° C./2.16 kg) | (g/dm3) |
| mLLDPE | Affinity | Dow | 1.6 | 896 |
| | PF1140 | | | |
| mLLDPE | Elite 5500G | Dow | 1.5 | 914 |
| mLLDPE | Enable | Exxon | 0.5 | 927 |
| | 27-05HH | | | |
| LDPE | LDJ225 | Qenos | 2.5 | 922 |
| HDPE | HDA001HP2 | ExxonMobil | 9.5* | 952 |
| Starch | BL-F | Cardia | 1.2 | 1.18 |
| containing | | Bioplastics | | |
| polymer | | | | |
| Antiblock | F20N | A. Schulman | | |
| masterbatch | | | | |
| Pro- | Renatura | Greenready | | |
| degradant | 1401551 GRP | Plastics | | |
| masterbatch | | | | |

*measured at 190° C./2.16 kg

A conventional three layer blown film line was used to prepare a number of film samples, films A-D, having a thickness of 80 μm and an ABC structure, where layer A represents the first outermost polymer layer, layer B represents the core polymer layer and layer C represents the second outermost layer according to the invention. The layer thickness configuration was 25% for layer A and layer C and 50% for the core layer B.

The film blowing line was equipped with three conventional extruders to feed the three layers of the film structure: extruder A and C, both, of 55 mm diameter, general purpose screw, smooth barrel, L/D 28:1, and extruder B of 65 mm diameter, general purpose screw, smooth barrel, L/D 28:1, Die gap=1.8 mm and a bubble height of 4.8 m.

Table 2 summarises the layer compositions of the films. Sample film A was produced as a comparative sample without adding a starch containing polymer composition. Sample films B-D were produced according to the invention with increasing amount of starch containing polymer composition included in the core layer. Layers A and C each represented 25% of the film, and layer B represented 50% of the film.

TABLE 2
Compositions used in the production of the multilayer films.

| | | | | | |
|---|---|---|---|---|---|
| | | | Starch | | |
| Layer | Main PE | Secondary PE | Polymer | Additive 1 | Additive 2 |

Film A CONTROL

| | | | | | | | | | | |
|---|---|---|---|---|---|---|---|---|---|---|
| A | Enable 27-05HH | 94% | | | BL-F | 0% | Blue Dark | 4% | Renatura | 2% |
| B | HDPE HAD | 25% | Exceed 101BHA | 73% | BL-F | 0% | | | Renatura | 2% |
| | 001HP2 | | | | | | | | | |
| C | Enable 27-05HH | 51% | Affinity PF1140 | 45% | BL-F | 0% | AntiBlock F20N | 2% | Renatura | 2% |

Film B 20% Biohybrid

| | | | | | | | | | | |
|---|---|---|---|---|---|---|---|---|---|---|
| A | Enable 27-05HH | 94% | | | BL-F | 0% | Blue Dark | 4% | Renatura | 2% |
| B | LDPE LDJ225 | 40% | Exceed 101BHA | 20% | BL-F | 20% | HDPE HAD 001HP2 | 18% | Renatura | 2% |
| C | Elite 5500G | 96% | | | BL-F | 0% | AntiBlock F20N | 2% | Renatura | 2% |

Film C 30% Biohybrid

| | | | | | | | | | | |
|---|---|---|---|---|---|---|---|---|---|---|
| A | Enable 27-05HH | 94% | | | BL-F | 0% | Blue Dark | 4% | Renatura | 2% |
| B | Elite 5500G | 40% | LDPE LDJ225 | 10% | BL-F | 30% | HDPE HAD 001HP2 | 18% | Renatura | 2% |
| C | Enable 27-05HH | 50% | Affinity PF1140 | 45% | BL-F | 0% | AntiBlock F20N | 3% | Renatura | 2% |

Film D 50% Biohybrid

| | | | | | | | | | | |
|---|---|---|---|---|---|---|---|---|---|---|
| A | Enable 27-05HH | 94% | | | BL-F | 0% | Blue Dark | 4% | Renatura | 2% |
| B | Elite 5500G | 30% | LDPE LDJ225 | 10% | BL-F | 50% | HDPE HAD 001HP2 | 8% | Renatura | 2% |
| C | Enable 27-05HH | 50% | Affinity PF1140 | 45% | BL-F | 0% | AntiBlock F20N | 3% | Renatura | 2% |

The processing conditions for film blowing were: extruder speeds A and C of 45 rpm and extruder speed B of 60 rpm, line speed of 50 m/min and a blow-up ratio of 3:1. Process temperatures for the control sample film A (without starch polymer) were extruder A-C Zone 1: 170° C., Zone 2: 220° C., Zone 3: 220, Adapter: 210° C., Die: 200° C. Process temperatures for the sample films B-D containing starch polymer were extruder A-C Zone 1: 150° C., Zone 2: 200° C., Zone 3: 200, Adapter: 200° C., Die: 195° C. The melt temperature was kept below about 200° C. to minimise starch decomposition and discoloration.

### Part B2-b—Bag Preparation

A vertical form fill and seal machine, type KN3000, manufactured by BiB Packaging, Canada, was used to form a bag, fill it with 101 of drinking water and seal it using the multi-layer films A-D made as per Part B2-a. The process was adjusted to account for the low seal initiation temperature of the seal layer of films to form the seals at a setting of 180-190° C. sealing temperature, a sealing time of 1-1.2 seconds and a cycle time of 11-13 seconds.

### Part B2-c—Bag/Film Performance

### Drop Test

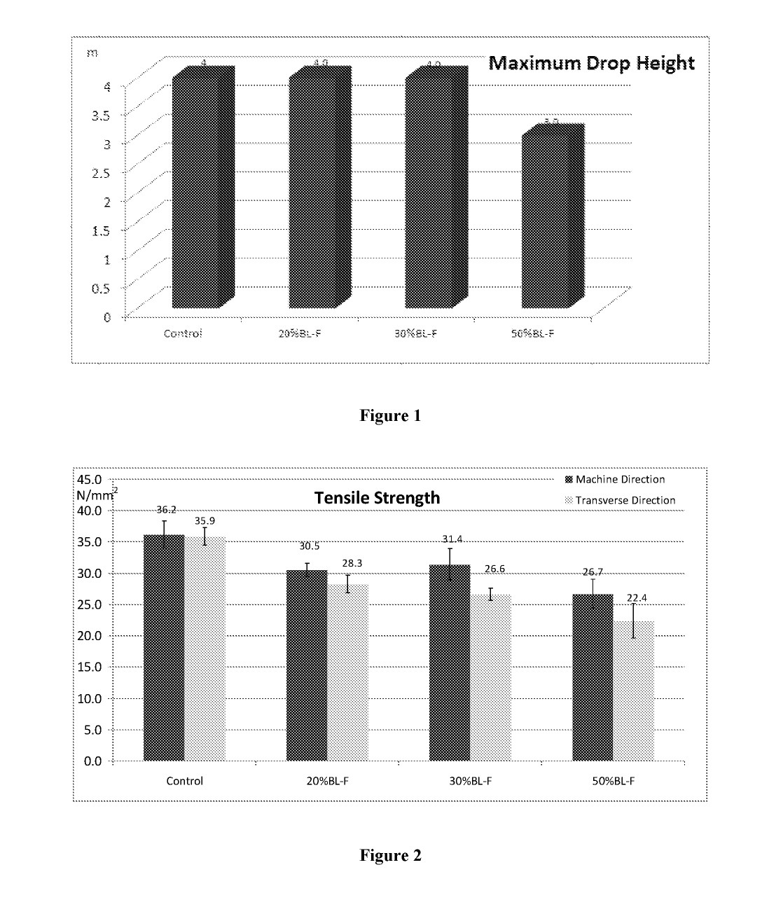

Water filled bags of 10 litre as per Part B2-b were tested using a simple drop test onto concrete from height in 1 meter increments up to 4 meters and subsequently inspecting the bags for tears, ruptures and leakages. Water filled bags produced as per Part B2-b all resulted in excellent drop test performance as illustrated in FIG. 1. Film samples A-C passed drop tests of greater than 4 meters without any leakages. Even film sample D containing passed the drop test at 3 meters height demonstrating the superior performance of the films according to this invention.

### Tensile

Tensile properties of the film used to make the bags was measured according to ASTM D882. Results of the test are shown in FIG. 2.

### Elongation at Break

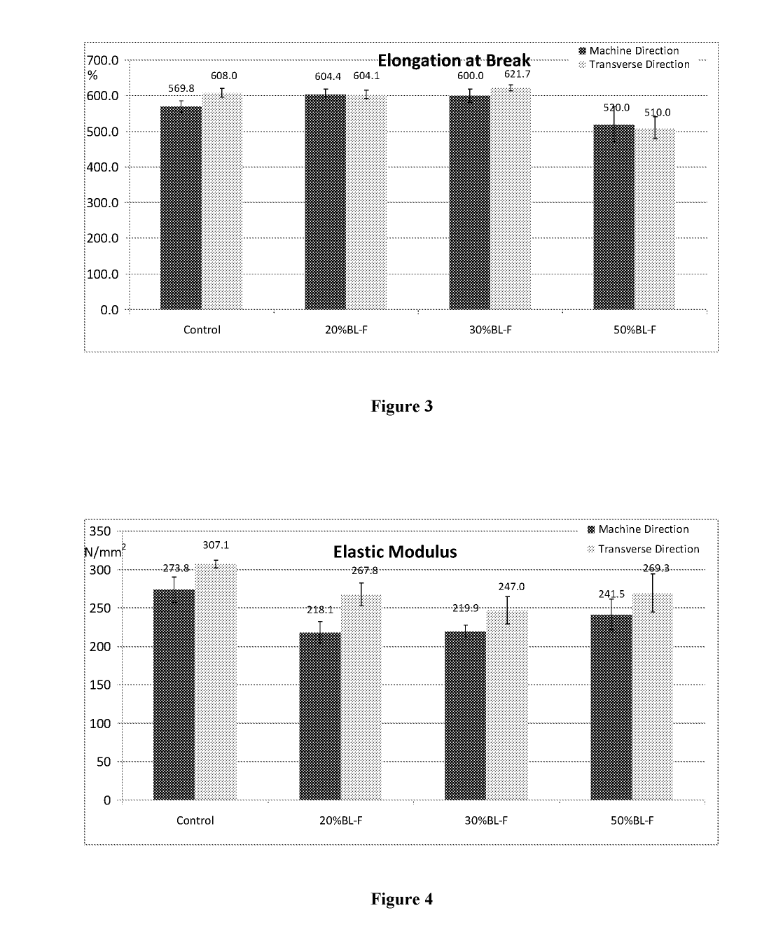

Elongation at break properties of the film used to make the bags was measured according to ASTM D882. Results of the test are shown in FIG. 3.

### Elastic Modulus

Elastic modulus properties of the film used to make the bags was measured according to ASTM D882. Results of the test are shown in FIG. 4.

### Dart Impact

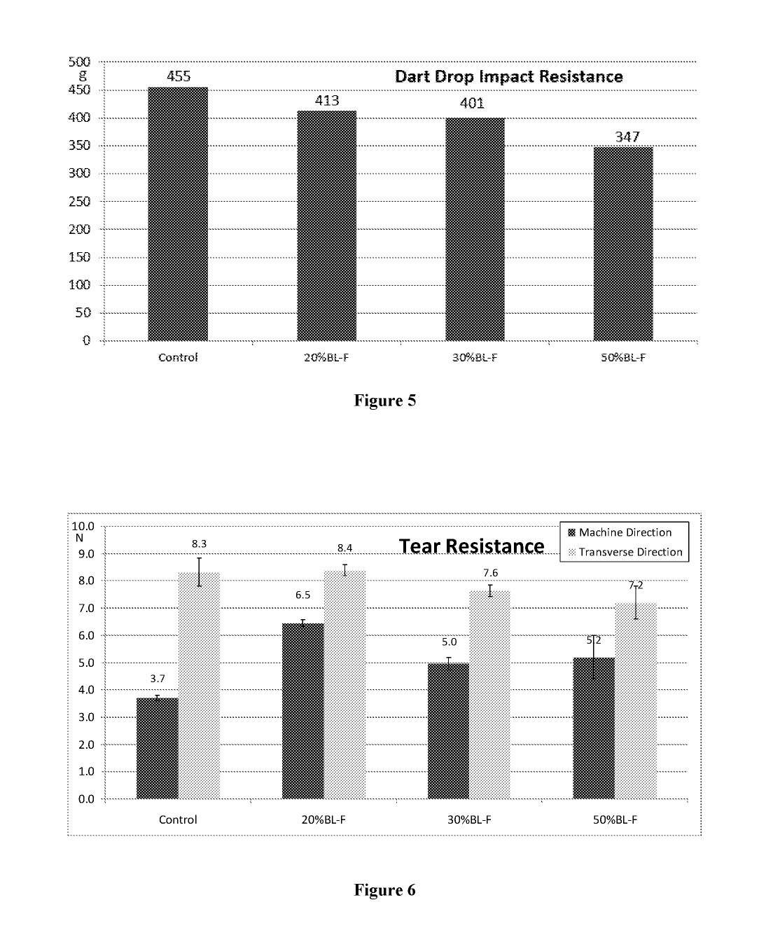

Dart impact properties of the film used to make the bags was measured according to ASTM D1709. Results of the test are shown in FIG. 5.

### Tear Test

Tear properties of the film used to make the bags was measured according to ASTM D1938. Results of the test are shown in FIG. 6.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A polymer film having a multilayer structure, the multilayer structure comprising an inner polymer layer interposed between first and second outermost polymer layers, wherein:
(i) the inner polymer layer comprises a melt blend of:
(a) a starch containing a polymer composition comprising polyethylene, thermoplastic starch, and one or more compatibilizers;
(b) a metallocene polyethylene having a melt flow index in the range of 0.5 to 2.5 g/10 min and a density in the range of 0.910 to 0.935 g/cm³;
(c) a polyethylene having a melt flow index in the range of 2 to 4 g/10 min and a density in the range of 0.918 to 0.925 g/cm³; and
(d) a polyethylene having a melt flow index in the range of 0.05 to 0.2 g/10 min and a density
in the range of 0.948 to 0.955 g/cm³;
(ii) the first and second outermost polymer layers independently (a) comprise a metallocene polyethylene having a melt flow index in the range of 0.5 to 2.5 g/10 min and a density in the range of 0.916 to 0.935 g/cm³, or (b) have a heat seal initiation temperature of no greater than 120° C., wherein at least one of the first and second outermost polymer layers has the heat seal initiation temperature of no greater than 120° C.

2. The polymer film according to claim 1, wherein the heat seal initiation temperature of no greater than 120° C. is provided by a polymer composition comprising a metallocene polyethylene having a melt flow index in the range of 1 to 15 g/10 min and a density in the range of 0.910 to 0.920 g/cm³.

3. The polymer film according to claim 1, wherein the heat seal initiation temperature of no greater than 120° C. is provided by a polymer composition comprising a melt blend of:
(i) a metallocene polyethylene having a melt flow index in the range of 1 to 15 g/10 min and a density in the range of 0.910 to 0.920 g/cm³; and
(ii) a metallocene polyethylene-co-α-olefin plastomer.

4. The polymer film according to claim 1, wherein at least one of the inner polymer layer and the first and second outermost polymer layers further comprises a pro-degradant.

5. The polymer film according to claim 1, wherein the polymer film is in the form of a sealed bag containing a consumer product.

6. The polymer film according to claim 5, wherein the consumer product is a food product or a drink product fit for animal or human consumption.

7. The polymer film according to claim 5, wherein the sealed bag is of a size that accommodates a volume of consumer product ranging from about 500 mL to about 30 L.

8. The polymer film according to claim 5, wherein the sealed bag is sealed in a plastic cover bag.

9. The polymer film according to claim 8, wherein the plastic cover bag is made from the polymer film according to claim 1.

10. The polymer film according to claim 1, wherein the one or more compatibilizers are selected from the group consisting of ethylene acrylic acid copolymer, ethylene methacrylic acid copolymer, polyethylene-co-vinyl acetate, polyethylene-co-vinyl alcohol, graft copolymer of polyethylene and maleic anhydride, and an ionomer.

11. The polymer film according to claim 1, wherein the inner polymer layer is in an amount of about 40 wt % to about 80 wt %, and each of the first and second outermost polymer layers independently is in an amount of about 10 wt % to about 30 wt %, of the total mass of the polymer film.

12. A process for producing a polymer film having a multilayer structure, the multilayer structure comprising an inner polymer layer interposed between first and second outmost polymer layers, the process comprising;
forming the multilayer structure by co-extruding the inner polymer layer interposed between the first and second outermost polymer layers, wherein:
(i) the inner polymer layer comprises a melt blend of:
(a) a starch containing a polymer composition comprising polyethylene, thermoplastic starch, and one or more compatibilizers;
(b) a metallocene polyethylene having a melt flow index in the range of 0.5 to 2.5 g/10 min and a density in the range of 0.916 to 0.935 g/cm³;
(c) a polyethylene having a melt flow index in the range of 2 to 4 g/10 min and a density in the range of 0.918 to 0.925 g/cm³; and
(d) a polyethylene have a melt flow index in the range of 0.05 to 0.2 g/10 min and a density in the range of 0.948 to 0.955 g/cm³;
(ii) the first and second outermost polymer layers independently (a) comprise a metallocene polyethylene having a melt flow index in the range of 0.5 to 2.5 g/10 min and a density in the range of 0.916 to 0.935 g/cm³, or (b) have a heat seal initiation temperature of no greater than 120° C., wherein at least one of the first and second outermost polymer layers has the heat seal initiation temperature of no greater than 120° C.

13. A sealed bag having a consumer product contained therein, the sealed bag comprising the polymer film according to claim 1.

14. The sealed bag according to claim 13, which the sealed bag is sealed in a plastic cover bag.

15. A process for producing a sealed bag having a consumer product contained therein, the process comprising;
bringing the consumer product into contact with the polymer film according to claim 1, and
heat-sealing the polymer film so as to form the sealed bag containing the consumer product.

16. A process for producing a sealed bag containing a consumer product, the process comprising;
forming the sealed bag using the polymer film according to claim 1,
filling the sealed bag with a consumer product, and
subsequently heat-sealing the sealed bag so as to form the sealed bag containing the consumer product.

17. The process according to claim 15, further comprising;
sealing the sealed bag in a plastic cover bag.
